(19) United States
(12) Patent Application Publication
(10) Pub. No.: US 2026/0338093 A1
(43) Pub. Date: Oct. 29, 2026

(54) ENGINE

(71) Applicant: KAWASAKI MOTORS, LTD., Akashi-shi (JP)

(72) Inventor: Yuji HIDA, Akashi-shi (JP)

(73) Assignee: KAWASAKI MOTORS, LTD., Akashi-shi (JP)

(21) Appl. No.: 19/699,315

(22) Filed: Jun. 5, 2026

Related U.S. Application Data
(63) Continuation of application No. PCT/JP2024/025450, filed on Jul. 16, 2024.

(30) Foreign Application Priority Data
Dec. 12, 2023 (JP) 2023-209059

(51) Int. Cl. F01M 13/04; F01M 1/02; F01M 11/00; F01M 11/02

(52) U.S. Cl. CPC F01M 13/04; F01M 1/02; F01M 11/0004; F01M 11/02

(57) ABSTRACT

An engine of the present disclosure comprises: a crankshaft that changes a reciprocating motion of a piston to a rotating motion; a crank case that supports the crankshaft; a cylinder that protrudes from the crank case to one side in a piston reciprocating direction; an oil pan that is attached to a lower side of the crank case and forms a liquid collection space for collecting oil that has lubricated a lubrication target portion in the crank case; and a scavenge pump that suctions oil from inside the liquid collection space and discharges the oil to an oil tank. A breather intake port is formed at a position facing the liquid collection space from above.

### CROSS REFERENCE TO THE RELATED APPLICATION

This application is a continuation application, under 35 U.S.C. §111(a) of international patent application No. PCT/JP2024/025450, filed Jul. 16, 2024, which claims priority to Japanese patent application No. 2023-209059, filed Dec. 12, 2023, the entire disclosures of all of which are herein incorporated by reference as a part of this application.

### BACKGROUND OF THE INVENTION

### Field of the Invention

The present disclosure relates to, for example, an engine used as a drive source for a vehicle.

### Description of Related Art

An engine is used as a drive source for a vehicle such as a motorcycle (e.g., Patent Document 1). Such an engine has a crank case breather in order to release pressure inside a crank case to the outside. Fluid taken into the crank case breather is subjected to gas-liquid separation. Thereafter, a gaseous component is delivered to an intake passage and a liquid component is delivered to an oil pan.

### RELATED DOCUMENT

### PATENT DOCUMENT

Patent Document 1 JP Laid-open Patent Publication No. 2014-065465

From the viewpoint of enhancing the gas-liquid separation effect, it is preferable that fluid supplied to the crank case breather contains a smaller liquid component. Accordingly, a breather intake port for taking in the fluid is preferably provided at a location where oil is subject to little agitation. For example, it is not preferable to provide the breather intake port in a cam chamber of a cylinder head in which a camshaft rotates, in a crank chamber of a crank case in which a crankshaft rotates, or the like. Although the oil is subject to little agitation in the interior of the oil pan located below the crank case, the interior is filled with oil. Thus, it has been difficult to provide the breather intake port in the oil pan.

### SUMMARY OF THE INVENTION

The disclosure of the present application provides an engine capable of enhancing the gas-liquid separation effect for fluid.

An engine according to the present disclosure includes: a crankshaft that changes a reciprocating motion of a piston to a rotating motion; a crank case that supports the crankshaft; a cylinder that protrudes from the crank case to one side in a piston reciprocating direction; an oil pan that is attached to a lower portion of the crank case and forms a liquid collection space for collecting oil that lubricates a lubrication target portion in the crank case; and a scavenge pump that suctions oil from inside the liquid collection space and discharges the oil to an oil tank, and a breather intake port is formed at a position facing the liquid collection space from above.

With the engine of the present disclosure, since the oil collected in the oil pan is discharged by the scavenge pump, an oil level in the oil pan does not become high. Accordingly, it is possible to prevent a liquid component of the oil in the oil pan from flowing from the breather intake port toward a breather chamber, thereby improving the gas-liquid separation effect for the fluid. In particular, when the breather intake port is disposed at a position facing the liquid collection space of the oil pan from above, that is, at a high position within the oil pan, the breather intake port is less likely to be affected by the oil level. As a result, the liquid component is less likely to be taken in through the breather intake port, thereby improving the gas-liquid separation effect for the fluid.

Any combination of at least two configurations disclosed in the appended claims and/or the specification and/or drawings is included in the present disclosure. In particular, any combination of two or more of the claims described in the appended claims is included in the present disclosure.

### BRIEF DESCRIPTION OF THE DRAWINGS

The present disclosure will be more clearly understood from the following description of a preferred embodiment with reference to the accompanying drawings. However, the embodiment and the drawings are provided solely for the purpose of illustration and description, and are not intended to define the scope of the present disclosure. The scope of the present disclosure is to be determined by the accompanying claims (the appended claims). In the accompanying drawings, like reference numerals are used to denote like parts throughout the several drawings:

FIG. 1 is a side view illustrating an engine according to a first embodiment of the present disclosure;

FIG. 2 is a front view illustrating the engine;

FIG. 3 is a bottom view of the engine as viewed from below;

FIG. 4 is an enlarged bottom view illustrating an IV portion in FIG. 3;

FIG. 5 is a perspective view illustrating a breather chamber of the engine;

FIG. 6 is a perspective view illustrating a state in which a cover member and a sealing member are removed from the breather chamber;

FIG. 7 is a perspective view illustrating a state in which a cover member is removed from the breather chamber;

FIG. 8 is a rear view of the cover member; and

FIG. 9 is a schematic view illustrating a flow of fluid in a breather structure of the engine.

### DESCRIPTION OF EMBODIMENTS

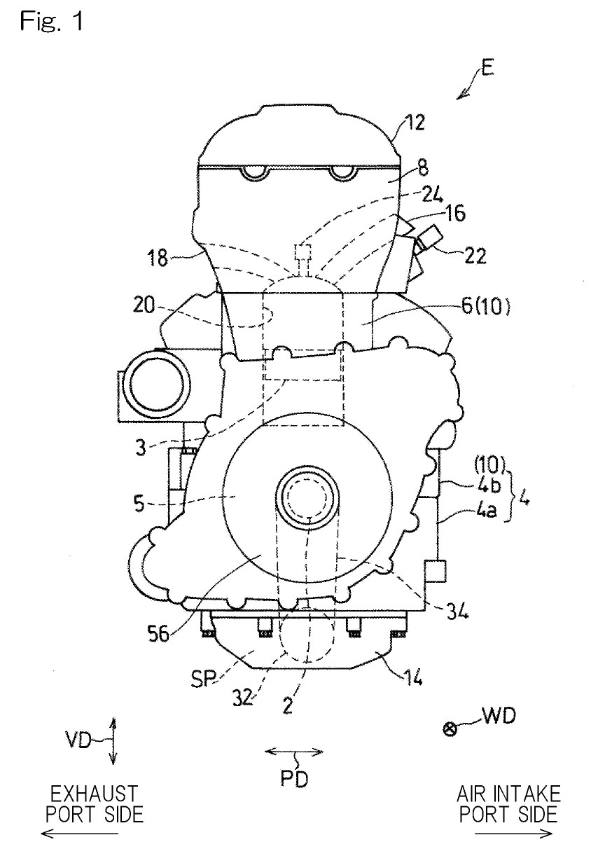

Hereinafter, a preferred embodiment of the present disclosure will be described with reference to FIGS. 1-9. An engine E of the present embodiment is a reciprocating engine, and is used, for example, in an aircraft in which a propeller is disposed at a front end of a fuselage. In this case, the engine E is housed in the fuselage, and engine power is transmitted to the propeller. The use of the engine E is not limited thereto. For example, the engine E is also applicable as a drive source for a watercraft, and is also applicable as a drive source for a wheeled vehicle such as a two-wheeled vehicle or a four-wheeled vehicle.

In the following description, a “widthwise direction WD” refers to a direction in which a crankshaft 2 of the engine E extends, that is, an axial direction of the crankshaft 2. In the widthwise direction WD, a direction toward a widthwise direction center is referred to as a “widthwise direction inner side”, and a direction away from the widthwise direction center is referred to as a “widthwise direction outer side”. A “reciprocating direction VD” refers to a direction along which a piston of the engine E reciprocates. A direction orthogonal to both the “widthwise direction WD” and the “reciprocating direction VD” is referred to as an “orthogonal direction PD”.

The engine E of the present embodiment is a six-cylinder engine in which six cylinders are arrayed in the direction in which the crankshaft 2 extends. However, the number of cylinders is not limited to six, and may be, for example, four. Furthermore, although the engine E of the present embodiment is a gasoline engine, the fuel is not limited to gasoline. The crankshaft 2 changes the reciprocating motion of a piston 3 to a rotating motion.

The engine E includes a crank case 4 that supports the crankshaft 2, a cylinder 6 that protrudes from the crank case 4 to one side in the reciprocating direction VD, and a cylinder head 8 coupled to a protruding end of the cylinder 6. The crankshaft 2 is disposed in a crank chamber 5 inside the crank case 4. In the following description, in the reciprocating direction VD, the direction in which the cylinder 6 protrudes from the crank case 4 is referred to as “upward”, and the opposite side is referred to as “downward”.

The crank case 4 is split into two halves in a vertical direction, and includes a crank case lower 4a and a crank case upper 4b. In the present embodiment, the crank case upper 4b and the cylinder 6 are integrally formed by molding. However, the crank case upper 4b and the cylinder 6 may be separate members. In the following description, an integral unit of the crank case upper 4b and the cylinder 6 is referred to as a cylinder block 10.

The engine E further includes a head cover 12 coupled to an upper end of the cylinder head 8. The cylinder head 8 and the cylinder head cover 12 form a cam chamber. In the cam chamber, a valve train is disposed that opens and closes intake and exhaust valves in interlock with rotation of the crankshaft 2.

The engine E further includes an oil pan 14 coupled to a lower end of the crank case 4. The oil pan 14 stores engine oil used to lubricate a lubrication target portion of the engine E. In other words, the oil pan 14 forms a liquid collection space SP for collecting oil that has lubricated the lubrication target portion of the engine E.

In the present embodiment, the crank case upper 4b constitutes a first case half coupled to the cylinder 6. On the other hand, the crank case lower 4a constitutes a second case half to which the oil pan 14 is coupled.

An air intake port 16 is open on a surface of the cylinder head 8 on one side in the orthogonal direction PD (the right side in FIG. 1), and an exhaust port 18 is open on a surface of the cylinder head 8 at the other side end in the orthogonal direction PD (the left side in FIG. 1). In the following description, in the orthogonal direction PD, the air-intake-port side is simply referred to as an “intake side”, and the exhaust-port side is simply referred to as an “exhaust side”.

The air intake port 16 and the exhaust port 18 are passages formed inside the cylinder head 8. The air intake port 16 has an upstream end that is open on one side of the cylinder head 8 in the orthogonal direction PD, and a downstream end that is open to a combustion chamber 20 inside the cylinder 6. The exhaust port 18 has an upstream end that is open to the combustion chamber 20 inside the cylinder 6, and a downstream end that is open on a front side of the cylinder head 8 on the other side in the orthogonal direction PD. The air intake port 16 is formed for each cylinder. Similarly, the exhaust port 18 is also formed for each cylinder.

External air is supplied as air intake to the combustion chamber 20 through the air intake port 16, and fuel is injected into the combustion chamber 20 from an injector 22, thereby forming an air-fuel mixture. The air-fuel mixture in the combustion chamber 20 is ignited by a spark plug 24 and the ignited air-fuel mixture is combusted. Exhaust gas produced by combustion is discharged to the outside of the engine through the exhaust port 18.

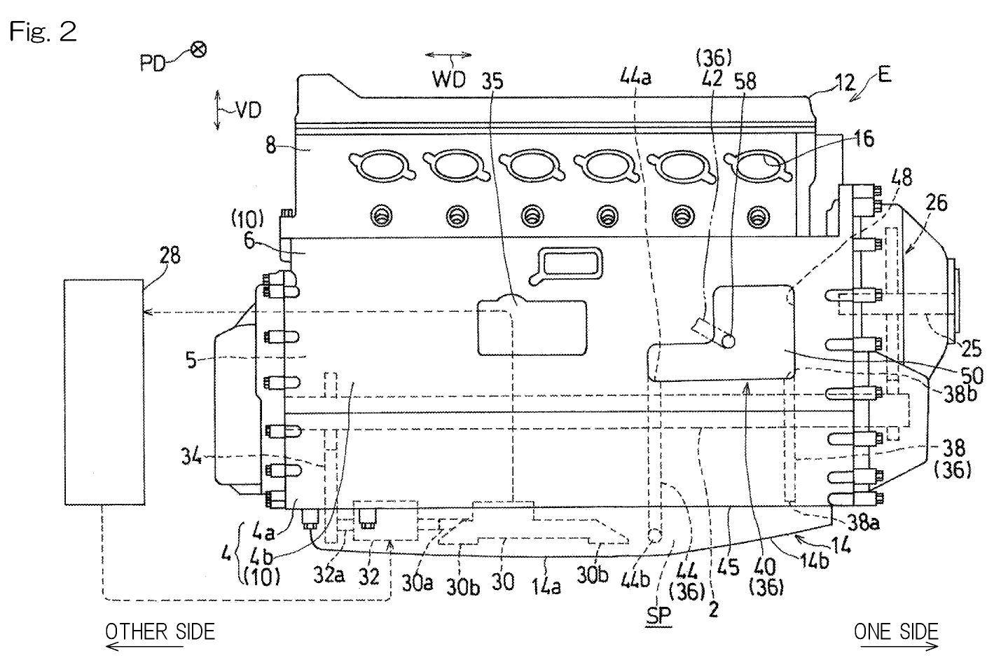

FIG. 2 is a front view of the engine E as viewed from the intake side in the orthogonal direction PD. As illustrated in FIG. 2, the engine E includes, on one side in the widthwise direction WD thereof (the right side in FIG. 2), an output shaft 25 and a reduction mechanism 26. Rotational power of the crankshaft 2 is reduced by the reduction mechanism 26 and transmitted to the output shaft 25. To the output shaft 25, the following are coupled directly or via a power transmission member: the propeller of an aircraft, the wheels of a wheeled vehicle, the rotor blades of a turbine, the impeller of a compressor, and the like.

The engine E of the present disclosure is an engine employing a dry-sump lubrication system and having a scavenge pump 30 that suctions oil from inside the liquid collection space SP of the oil pan 14 and discharges the oil to an oil tank 28.

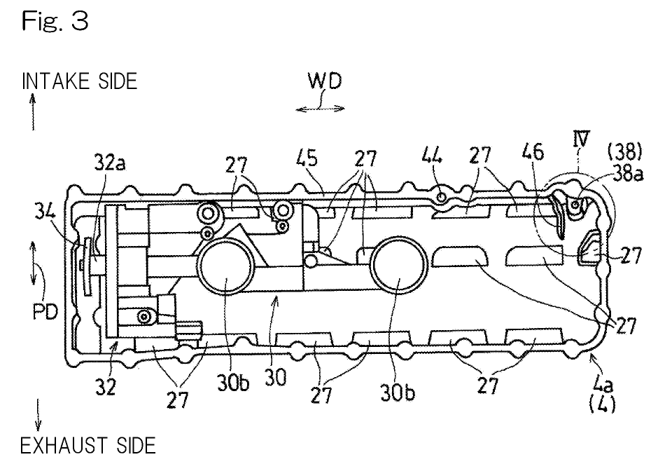

In the present embodiment, the oil tank 28 is provided outside the engine E, that is, spaced apart from the engine E. The oil discharged from the scavenge pump 30 is stored in the oil tank 28 and then pressurized by a feed pump 32 to lubricate the lubrication target portion of the engine E. The oil that has been used to lubricate the lubrication target portion is returned to the oil pan 14 via an up and down passage 27 (FIG. 3). The up and down passage 27 is a passage communicating the crank chamber 5 and the oil pan 14.

In the present embodiment, the oil pan 14 includes a bottom wall 14a that constitutes the deepest portion, and an inclined wall 14b that extends while being inclined upward with increasing distance from the bottom wall 14a in a horizontal direction (the engine widthwise direction WD in the present embodiment).

In the present embodiment, the scavenge pump 30 is disposed inside the oil pan 14. Specifically, the scavenge pump 30 is disposed at the deepest portion of the oil pan 14. The scavenge pump 30 suctions oil in the liquid collection space SP of the oil pan 14 and discharges the oil to the outside of the liquid collection space SP. Accordingly, in the oil pan 14, the oil level does not become high, and a large amount of a gaseous component of the oil exists within the liquid collection space SP.

In the present embodiment, the scavenge pump 30 is driven in interlock with rotation of the crankshaft 2. Specifically, the rotational power of the crankshaft 2 is transmitted to the scavenge pump 30 by a power transmission member 34 such as a drive chain.

In the present embodiment, the feed pump 32 is also disposed in the oil pan 14. Specifically, the feed pump 32 is disposed at the deepest portion of the oil pan 14, on the other side in the widthwise direction WD of the engine E (the left side in FIG. 2) within the oil pan 14. The scavenge pump 30 and the feed pump 32 are disposed side by side in the engine widthwise direction WD.

In the present embodiment, the feed pump 32 is also driven in interlock with rotation of the crankshaft 2. Specifically, the rotational power of the crankshaft 2 is transmitted to the feed pump 32 by the power transmission member 34 such as a drive chain.

In the present embodiment, the rotational power of the crankshaft 2 is transmitted to both the scavenge pump 30 and the feed pump 32 by the common power transmission member 34. Specifically, a rotation shaft 30a of the scavenge pump 30 and a rotation shaft 32a of the feed pump 32 are disposed coaxially, and the two rotation shafts 30a and 32a are coupled to each other. The power transmission member 34 is looped around the rotation shaft 32a of the feed pump 32, and rotational power of the crankshaft 2 is transmitted via the power transmission member 34 to the rotation shaft 32a of the feed pump 32 and to the rotation shaft 30a of the scavenge pump 30 coupled to the rotation shaft 32a.

When the engine E is started, the scavenge pump 30 and the feed pump 32 are driven in interlock with rotation of the crankshaft 2. The feed pump 32 pressure-feeds the oil stored in the oil tank 28 to the lubrication target portion of the engine E. The oil that has been used to lubricate the lubrication target portion is returned to the oil pan 14 via the up and down passage 27. The oil in the liquid collection space SP of the oil pan 14 is collected by the scavenge pump 30, cooled by an oil cooler 35, and then supplied to the oil tank 28.

A breather structure 36 of the crank case 4 of the engine E of the present embodiment will be described. The interior of the crank case 4 is at a pressure higher than atmospheric pressure due to blow-by gas and oil vapor. The breather structure 36 of the crank case 4 is operable to release such pressure, that is, to release fluid inside the engine to the outside.

The breather structure 36 includes a breather introduction passage 38, a breather chamber 40, a breather discharge passage 42, and a return passage 44. Fluid F inside the crank case 4 is taken in through the breather introduction passage 38 and flows into the breather chamber 40. The fluid F is separated in the breather chamber 40 into a gaseous component Fg and a liquid component Fl. The gaseous component Fg is delivered to an intake system of the engine E through the breather discharge passage 42 and is supplied to the combustion chamber 20 (FIG. 1) together with air intake. The liquid component Fl is returned to the interior of the crank case 4 through the return passage 44. Details will be described below.

In the present embodiment, the breather introduction passage 38 is an internal passage formed inside the crank case 4. Specifically, the breather introduction passage 38 is formed in the vicinity of a wall surface of the crank case 4 on the intake side in the orthogonal direction PD. More specifically, the breather introduction passage 38 is formed on one side in the engine widthwise direction WD (the right side in FIG. 2) on the wall surface of the crank case 4 on the intake side.

The breather introduction passage 38 extends in a vertical direction. A breather intake port 38a at a lower end of the breather introduction passage 38 is open to the liquid collection space SP of the oil pan 14, and a breather outlet 38b at an upper end of the breather introduction passage 38 is open to the breather chamber 40.

The breather intake port 38a is disposed at a position facing the liquid collection space SP of the oil pan 14 from above. In the vertical direction, the breather intake port 38a is disposed at a position higher than a suction port 30b of the scavenge pump 30. Furthermore, the breather intake port 38a is formed at a portion of the crank case 4 above a mating surface 45 with the oil pan 14.

Specifically, the breather intake port 38a is formed in the crank case lower 4a of the crank case 4 and, as illustrated in FIG. 3, which is a view of the crank case 4 as viewed from below, is disposed on an inner side of the mating surface 45, that is, on the liquid collection space SP side.

As illustrated in FIG. 2, in the engine widthwise direction WD, the breather intake port 38a is disposed so as to face the inclined wall 14b of the oil pan 14. That is, the breather intake port 38a is disposed above the inclined wall 14b of the oil pan 14. Furthermore, the breather intake port 38a is disposed on one side in the engine widthwise direction WD relative to the scavenge pump 30. In the present embodiment, the breather intake port 38a is disposed in the vicinity of a wall surface of the oil pan 14 on one side in the engine widthwise direction WD.

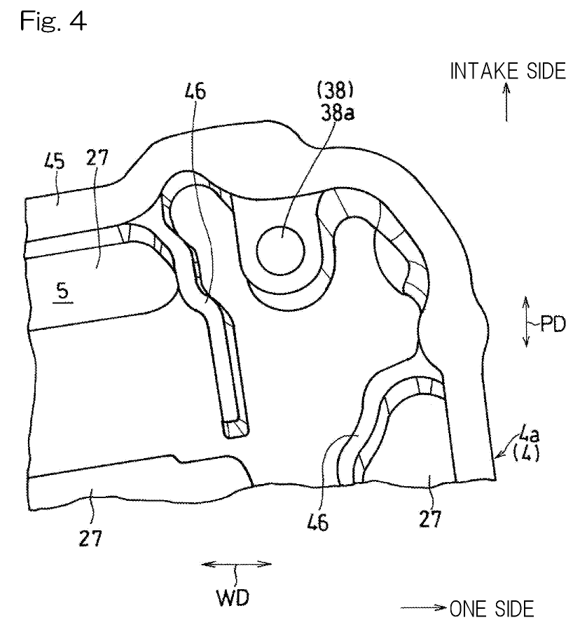

As illustrated in FIG. 4, an upstanding wall 46 is provided around the breather intake port 38a at a lower end portion of the crank case 4. The upstanding wall 46 prevents oil from flowing toward the breather intake port 38a. In the present embodiment, the upstanding wall 46 is integrally formed with the crank case 4 by molding. The upstanding wall 46 extends in a direction VD intersecting the axial direction of the crankshaft 2, that is, intersecting the engine widthwise direction WD.

The upstanding wall 46 is disposed between the up and down passage 45 and the breather intake port 38a. In the present embodiment, with respect to the breather intake port 38a, a wall of the crank case 4 is provided on the intake side in the orthogonal direction PD and on one side in the engine widthwise direction WD (the right side in FIG. 4). The upstanding wall 46 is provided on the exhaust side in the orthogonal direction PD and on the other side in the engine widthwise direction WD (the left side in FIG. 4) with respect to the breather intake port 38a. That is, the breather intake port 38a is surrounded over substantially an entire circumference by the wall of the crank case 4 and the upstanding wall 46.

As illustrated in FIG. 2, the breather chamber 40 is formed in the crank case upper 4b of the crank case 4. Specifically, the breather chamber 40 is provided on the air-intake-port side of the crank case 4 in the orthogonal direction PD. The breather chamber 40 is supplied with the fluid taken in through the breather intake port 38a. The breather chamber 40 has a plurality of rooms, and the fluid is subjected to gas-liquid separation by repeatedly flowing into and out of the rooms.

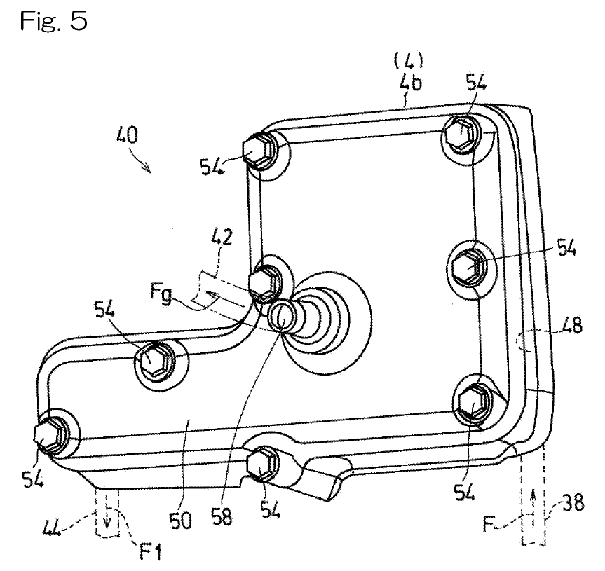

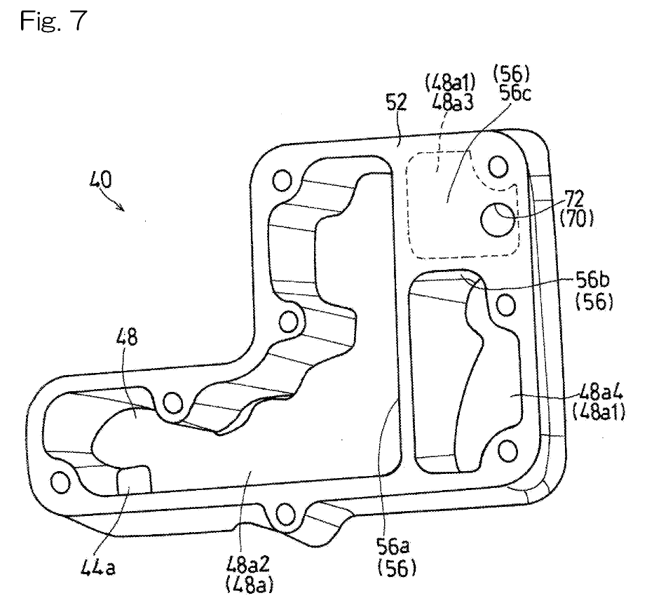

In the present embodiment, the breather chamber 40 is formed by a recess 48 formed in the crank case 4 and a cover member 50 attached to the crank case 4. Specifically, as illustrated in FIG. 5, the cover member 50 is detachably attached to the crank case 4 via a sealing member 52 (FIG. 7) using a plurality of bolts 54. The sealing member 52 is, for example, a graphite gasket. However, the sealing member 52 is not limited thereto.

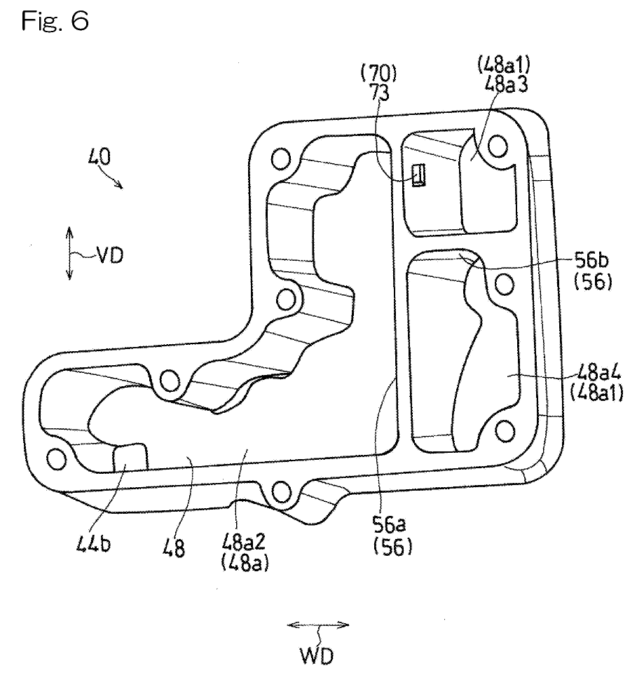

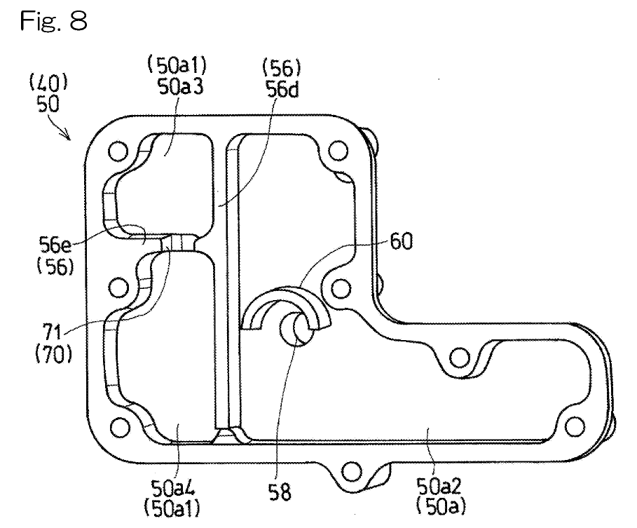

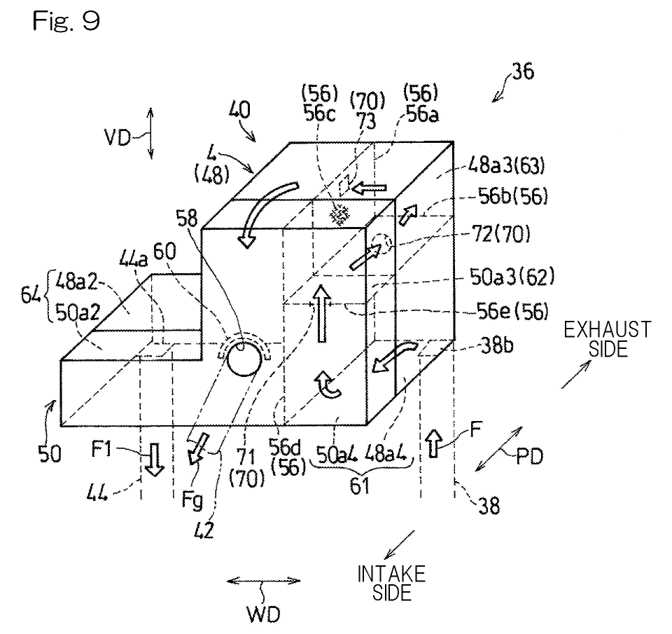

As illustrated in FIG. 9, the breather chamber 40 of the present embodiment has four rooms 61, 62, 63, and 64 partitioned by a plurality of partition walls 56. The structure of each of the rooms 61, 62, 63, and 64 of the breather chamber 40 of the present embodiment will be described with reference to FIGS. 6-9. FIG. 6 illustrates a state in which the cover member 50 and the sealing member 52 are removed, FIG. 7 illustrates a state in which only the cover member 50 is removed, and FIG. 8 illustrates a rear surface of the cover member 50. FIG. 9 is a perspective view schematically illustrating the flow of the fluid F in the breather chamber 40.

As illustrated in FIG. 6, the breather chamber 40 is formed with a first partition wall 56a that partitions an internal space 48a of the recess 48. The first partition wall 56a is a wall extending in the vertical direction VD from an upper end to a lower end of the recess 48 of the breather chamber 40, and divides the internal space 48a of the recess 48 in the engine widthwise direction WD. In the following description, among portions of the internal space 48a of the recess 48 partitioned by the first partition wall 56a, a portion on one side in the engine widthwise direction WD is referred to as a first portion 48a1, and a portion on the other side is referred to as a second portion 48a2.

Furthermore, a second partition wall 56b that partitions the first portion 48a1 into upper and lower regions is formed in the recess 48 of the breather chamber 40. The second partition wall 56b is a wall extending in the engine widthwise direction WD from the first partition wall 56a to an outer wall of the recess 48, and divides the first portion 48a1 in the vertical direction VD. In the following description, among portions of the first portion 48a1 partitioned by the second partition wall 56b, an upper portion is referred to as a third portion 48a3 and a lower portion is referred to as a fourth portion 48a4.

As illustrated in FIG. 7, a gasket 52, which is a type of sealing member, is interposed on end faces of an outer peripheral wall of the recess 48 of the breather chamber 40, the first partition wall 56a, and the second partition wall 56b. In the present embodiment, the sealing member 52 closes the third portion 48a3 of the internal space 48a of the recess 48 from the outside, that is, from the intake side in the orthogonal direction PD. That is, a portion of the sealing member 52 that closes the third portion 48a3 from the outside constitutes a third partition wall 56c. Thus, in the present embodiment, one of the partition walls 56 is constituted by the sealing member 52.

As illustrated in FIG. 8, a fourth partition wall 56d is formed in a portion of the rear surface of the cover member 50 corresponding to the first partition wall 56a, and a fifth partition wall 56e is formed in a portion of the rear surface of the cover member 50 corresponding to the second partition wall 56b.

The fourth partition wall 56d partitions an internal space 50a of the cover member 50 into a first portion 50a1 on one side in the engine widthwise direction WD (the left side in FIG. 8) and a second portion 50a2 on the other side (the right side in FIG. 8). The fifth partition wall 56e partitions the first portion 50a1 of the internal space 50a of the cover member 50 into a third portion 50a3 on the upper side and a fourth portion 50a4 on the lower side.

The cover member 50 has a gas outlet 58 for discharging the gaseous component in the breather chamber 54 to the outside. In the present embodiment, the gas outlet 58 is provided slightly below an intermediate portion in the vertical direction of the cover member 50. The breather discharge passage 42 (FIG. 2) is connected to the gas outlet 58.

Furthermore, a baffle plate 60 is formed on an inner surface, that is, the rear surface, of the cover member 50. The baffle plate 60 protrudes from the inner surface of the cover member 50 toward the inside of the breather chamber 40 and covers at least a part of the gas outlet 58 in a circumferential direction. In the present embodiment, the baffle plate 60 has an arcuate shape and covers the upper side of the gas outlet 58.

As illustrated in FIG. 9, in a state where the cover member 50 is attached to the crank case 4, the second portion 48a2 of the internal space 48a of the recess 48 communicates with the second portion 50a2 of the internal space 50a of the cover member 50.

Similarly, in the state where the cover member 50 is attached to the crank case 4, the third portion 48a3 of the internal space 48a of the recess 48 communicates with the third portion 50a3 of the internal space 50a of the cover member 50. However, the third portion 48a3 of the internal space 48a of the recess 48 and the third portion 50a3 of the internal space 50a of the cover member 50 are partitioned by the third partition wall 56c of the sealing member 52.

Furthermore, in the state where the cover member 50 is attached to the crank case 4, the fourth portion 48a4 of the internal space 48a of the recess 48 communicates with the fourth portion 50a4 of the internal space 50a of the cover member 50.

Thus, the fourth portion 48a4 of the internal space 48a of the recess 48 and the fourth portion 50a4 of the internal space 50a of the cover member 50 form the first room 61 of the breather chamber 40. Furthermore, the third portion 50a3 of the internal space 50a of the cover member 50 forms the second room 62 of the breather chamber 40, and the third portion 48a3 of the internal space 48a of the recess 48 forms the third room 63 of the breather chamber 40. Furthermore, the second portion 48a2 of the internal space 48a of the recess 48 and the second portion 50a2 of the internal space 50a of the cover member 50 form the fourth room 64 of the breather chamber 40.

The fluid flows in the order of the first room 61, the second room 62, the third room 63, and the fourth room 64. The rooms adjacent in the flow direction communicate with each other through communication holes 70 formed in the partition walls 56. The breather outlet 38b of the breather introduction passage 38 is open at an exhaust-side portion of a bottom wall of the first room 61 in the orthogonal direction PD. As illustrated in FIG. 8, the fifth partition wall 56e of the cover member 50 has a first communication hole 71. The first room 61 and the second room 62 in FIG. 9 communicate with each other through the first communication hole 71.

As illustrated in FIG. 7, the third partition wall 56c of the sealing member 52 has a second communication hole 72. The second room 62 and the third room 63 in FIG. 9 communicate with each other through the second communication hole 72. As illustrated in FIG. 6, a portion of the first partition wall 56a that constitutes the third room 63 has a third communication hole 73. The third room 63 and the fourth room 64 in FIG. 9 communicate with each other through the third communication hole 73.

The flow of the fluid F in the breather chamber 40 of the present embodiment will be described. The fluid F flowing into the first room 61 from the breather outlet 38b of the breather introduction passage 38 flows in the first room 61 toward the intake side in the orthogonal direction PD, then changes direction upward and flows into the second room 62 through the first communication hole 71.

The fluid F flowing into the second room 62 flows in the second room 62 toward the exhaust side in the orthogonal direction PD, and flows into the third room 63 through the second communication hole 72. The fluid F flowing into the third room 63 flows in the third room 63 toward the exhaust side in the orthogonal direction PD, then changes direction toward the widthwise direction WD and flows into the fourth room 64 through the third communication hole 73. The fluid F flowing into the fourth room 64 changes direction from the widthwise direction WD downward and flows.

In this manner, by repeatedly flowing into and out of the rooms 61, 62, 63, and 64 while changing the flow direction, the fluid F collides with the partition walls 56 and undergoes expansion and contraction, thereby promoting gas-liquid separation. In the fourth room 64, the separated gaseous component Fg of the fluid F is delivered from the gas outlet 58 through the breather discharge passage 42 to the intake system of the engine E. Meanwhile, the separated liquid component Fl of the fluid F is returned to the oil pan 14 through the return passage 44. At this time, the baffle plate 60 above the gas outlet 58 prevents the liquid component Fl from flowing into the gas outlet 58.

An inlet 44a of the return passage 44 is open at a portion of a bottom wall of the fourth room 64 on the other side in the engine widthwise direction WD. The return passage 44 extends downward from the breather chamber 40, and as illustrated in FIG. 2, an oil return port 44b serving as an outlet is open to the oil pan 14. The liquid component Fl of the fluid F is returned to the oil pan 14 through the return passage 44.

In the present embodiment, the return passage 44, like the breather introduction passage 38, is an internal passage formed inside the crank case 4. The return passage 44 extends in the vertical direction, and the oil return port 44b at a lower end is open to the liquid collection space SP of the oil pan 14.

The oil return port 44b is open in the liquid collection space SP at a position closer to the suction port 30b of the scavenge pump 30 than the breather intake port 38a. In the present embodiment, a portion (a lower end portion) of the return passage 44 is formed in the wall of the oil pan 14, and extends downward to the vicinity of the suction port 30b of the scavenge pump 30. In the present embodiment, the oil return port 44b is open toward the suction port 30b of the scavenge pump 30.

With the above configuration, since oil collected in the oil pan 14 is discharged by the scavenge pump 30, the oil level in the oil pan 14 does not become high. Accordingly, it is possible to prevent a liquid component of the oil in the oil pan 14 from flowing from the breather intake port 38a toward the breather chamber 40, thereby improving the gas-liquid separation effect for the fluid F. In particular, since the breather intake port 38a is disposed at a position facing the liquid collection space SP of the oil pan 14 from above, that is, at a high position within the oil pan 14, the breather intake port 38a is less likely to be affected by the oil level. As a result, the liquid component is less likely to be taken in through the breather intake port 38a, thereby improving the gas-liquid separation effect for the fluid F.

In the present embodiment, the breather intake port 38a is formed at a position higher than the suction port 30b of the scavenge pump 30. With this configuration, due to suction by the scavenge pump 30, the breather intake port 38a can be readily disposed upward away from the oil level. Accordingly, it is possible to prevent oil from flowing from the breather intake port 38a toward the breather chamber 40. As a result, the gas-liquid separation effect for the fluid F is improved.

In the present embodiment, the breather intake port 38a is formed at the portion of the crank case 4 above the mating surface 45 with the oil pan 14. With this configuration, the breather intake port 38a can be readily disposed upward away from the oil level. This makes it possible to prevent oil from flowing from the breather intake port 38a toward the breather chamber 40 even when orientation of the engine changes. As a result, the gas-liquid separation effect for the fluid F is improved.

In the present embodiment, the breather intake port 38a is disposed nearer the wall surface of the oil pan 14 in the axial direction of the crankshaft 2, that is, in the engine widthwise direction WD, than the scavenge pump 30. With this configuration, the scavenge pump 30 can be readily disposed away from the breather intake port 38a, and therefore, oil splashes generated during suction can be prevented from entering the breather intake port 38a. As a result, the gas-liquid separation effect for the fluid F is improved.

In the present embodiment, the oil pan 14 includes the bottom wall 14a constituting the deepest portion, and the inclined wall 14b extending upward with increasing distance from the bottom wall 14a in the horizontal direction, and the breather intake port 38a is disposed above the inclined wall 14b. With this configuration, since oil is unlikely to accumulate on the inclined wall 14b, it is possible to prevent oil from flowing from the breather intake port 38a toward the breather chamber 40. As a result, the gas-liquid separation effect for the fluid F is improved.

In the present embodiment, as illustrated in FIG. 3, the upstanding wall 46 that prevents oil from flowing toward the breather intake port 38a is provided. With this configuration, it is possible to prevent oil from flowing from the breather intake port 38a toward the breather chamber 40. As a result, the gas-liquid separation effect for the fluid F is improved.

In the present embodiment, the upstanding wall 46 extends in a direction intersecting the axial direction of the crankshaft 2, that is, intersecting the engine widthwise direction WD. With this configuration, even when oil in the oil pan 14 flows in the axial direction of the crankshaft 2 due to an orientation change, the upstanding wall 46 can prevent oil from entering the breather intake port 38a. As a result, the gas-liquid separation effect for the fluid F is improved.

In the present embodiment, the upstanding wall 46 is disposed between the up and down passage 27 communicating with the crank chamber 5 and the breather intake port 38a. With this configuration, the upstanding wall 46 can prevent oil flowing downward through the up and down passage 27 from entering the breather intake port 38a. As a result, the gas-liquid separation effect for the fluid F is improved.

In the present embodiment, the breather chamber 40 is provided on the air-intake-port side of the crank case 4 in the orthogonal direction PD, and the breather intake port 38a is disposed in the vicinity of a wall surface on the air-intake-port side with respect to the orthogonal direction PD. With this configuration, the breather chamber 40 can be disposed, relative to the breather intake port 38a, on the intake side that is relatively low in temperature, while shortening a passage from the breather intake port 38a to the breather chamber 40.

In the present embodiment, the breather intake port 38a is formed in the crank case lower 4a on the lower side, and the breather chamber 40 is formed in the crank case upper 4b on the upper side. With this configuration, the breather introduction passage 38 extending from the crank case lower 4a toward the crank case upper 4b is formed long, and the fluid is subjected to gas-liquid separation also within the breather introduction passage 38. As a result, the gas-liquid separation effect is improved. Furthermore, since the breather chamber 40 is spaced apart from the oil pan 14, it is possible to cope with a case where orientation of the engine E changes and the liquid level tilts.

In the present embodiment, the breather chamber 40 is formed by the recess 48 formed in the crank case 4 and the cover member 50 attached to the crank case 4. With this configuration, by changing the shape of the cover member 50, the volume of the breather chamber 40 can be adjusted.

In the present embodiment, the cover member 50 has the gas outlet 58 for discharging the gaseous component Fg in the breather chamber 40 to the outside, and the baffle plate 60 in FIG. 8 covering at least a part of the gas outlet 58 in the circumferential direction is formed on the inner surface of the cover member 50. With this configuration, it is possible to prevent the liquid component Fl of the fluid F, which has been subjected to gas-liquid separation in the breather chamber 40, from flowing toward the gas outlet 58.

In the present embodiment, the cover member 50 illustrated in FIG. 5 is attached to the crank case 4 via the sealing member 52, the breather chamber 40 includes the partition walls 56 that partition the breather chamber 40 into the plurality of rooms 61 to 64 and the communication holes 70 formed in the partition walls 56, and at least one of the partition walls 56 is constituted by the sealing member 52. With this configuration, since the sealing member 52 can be used as the partition wall 56, it is possible to reduce the number of partition walls 56 to be provided in the crank case 4, thereby simplifying the structure.

In the present embodiment, the oil return port 44b that returns the liquid component Fl in the breather chamber 40 to the inside of the oil pan 14 is open at a position closer to the suction port 30b of the scavenge pump 30 than the breather intake port 38a. With this configuration, since the discharged liquid component Fl from the oil return port 44b is sucked in through the suction port 30b of the scavenge pump 30, the liquid in the oil pan 14 can be efficiently discharged.

The engine of the present disclosure is suitably mounted on a mobile object such as an aircraft or a wheeled vehicle. The engine of the present disclosure is also suitably mounted on, for example, an off-road wheeled vehicle such as a four-wheeled buggy (all-terrain wheeled vehicle), a utility vehicle, or a recreational vehicle.

In the present embodiment, the breather introduction passage 38 is an internal passage. However, as long as the breather intake port 38a is formed at a position facing the liquid collection space SP from above, the breather introduction passage 38 may be an external passage, that is, separate piping. In the case of an external passage, one end of the piping is disposed at a position facing the liquid collection space SP from above, and the other end communicates with the breather chamber 40 through a route passing outside the engine.

The present disclosure is not limited to the above embodiment, and various additions, modifications, or deletions may be made without departing from the gist of the present disclosure. For example, the engine E of the above embodiment is also applicable to a straddle-riding vehicle such as a motorcycle, a three-wheeled vehicle, or a four-wheeled buggy (all-terrain wheeled vehicle). The engine E may be used for an outboard motor, or may be used as a propulsion source for an aircraft. Additionally, the engine E may be used as a propulsion source for a four-wheeled vehicle or a small planing boat. The number of cylinders is not limited to six, and may be less than six or may be seven or more. The engine E may be provided with a supercharging device such as a turbocharger or a supercharger. Accordingly, such variations are also included in the scope of the present disclosure.

### REFERENCE SYMBOLS

2 Crankshaft
3 Piston
4 Crank case
4a Second case half (crank case lower)
4b First case half (crank case upper)
5 Crank chamber
6 Cylinder
14 Oil pan
14a Bottom wall (deepest portion)
14b Inclined wall
16 Air intake port
18 Exhaust port
27 Up and down passage
28 Oil tank
30 Scavenge pump
30b Suction port of scavenge pump
38a Breather intake port
40 Breather chamber
45 Mating surface between crank case and oil pan
46 Upstanding wall
48 Recess
50 Cover member
52 Sealing member
56 Partition wall
58 Gas outlet
60 Baffle plate
61 to 64 Room
70 Communication hole
E Engine
SP Liquid collection space

What is claimed is:

1. An engine comprising:
a crankshaft that changes a reciprocating motion of a piston to a rotating motion;
a crank case that supports the crankshaft;
a cylinder that protrudes from the crank case to one side in a piston reciprocating direction;
an oil pan that is attached to a lower portion of the crank case and forms a liquid collection space for collecting oil that lubricates a lubrication target portion in the crank case; and
a scavenge pump that suctions oil from inside the liquid collection space and discharges the oil to an oil tank, wherein
a breather intake port is formed at a position facing the liquid collection space from above.

2. The engine according to claim 1, wherein the breather intake port is formed at a position higher than a suction port of the scavenge pump.

3. The engine according to claim 1, wherein the breather intake port is formed at a portion of the crank case above a mating surface with the oil pan.

4. The engine according to claim 1, wherein the breather intake port is disposed nearer a wall surface of the oil pan in an axial direction of the crankshaft than the scavenge pump is.

5. The engine according to claim 1, wherein
the oil pan includes a bottom wall constituting a deepest portion, and an inclined wall extending upward with increasing distance from the bottom wall in a horizontal direction, and
the breather intake port is disposed so as to face the inclined wall.

6. The engine according to claim 1, further comprising an upstanding wall that prevents oil from flowing toward the breather intake port.

7. The engine according to claim 6, wherein the upstanding wall extends in a direction intersecting an axial direction of the crankshaft.

8. The engine according to claim 6, wherein the upstanding wall is disposed between an up and down passage communicating with a crank chamber in which the crankshaft is disposed and the breather intake port.

9. The engine according to claim 1, wherein
an air intake port and an exhaust port are respectively disposed on one side and an other side in an orthogonal direction orthogonal to both an axial direction of the crankshaft and a vertical direction,
a breather chamber supplied with fluid taken in through the breather intake port is provided on an air-intake-port side of the crank case in the orthogonal direction, and
the breather intake port is disposed in the vicinity of a wall surface on the air-intake-port side with respect to the orthogonal direction.

10. The engine according to claim 1, wherein
the crank case includes a first case half to which the cylinder is coupled and a second case half to which the oil pan is coupled,
the breather intake port is formed in the second case half, and
a breather chamber supplied with fluid taken in through the breather intake port is formed in the first case half.

11. The engine according to claim 1, wherein
a breather chamber supplied with fluid taken in through the breather intake port is formed in the crank case, and
the breather chamber is formed by a recess formed in the crank case and a cover member attached to the crank case.

12. The engine according to claim 11, wherein
the cover member has a gas outlet for discharging a gaseous component in the breather chamber to outside, and
a baffle plate covering at least a part of the gas outlet in a circumferential direction is formed on an inner surface of the cover member.

13. The engine according to claim 11, wherein
the cover member is attached to the crank case via a sealing member,
the breather chamber includes partition walls that partition the breather chamber into a plurality of rooms, and communication holes formed in the partition walls, and
at least one of the partition walls is constituted by the sealing member.

14. The engine according to claim 1, wherein
a breather chamber supplied with fluid taken in through the breather intake port is formed in the crank case, and
an oil return port that returns a liquid component in the breather chamber to an inside of the oil pan is open at a position closer to a suction port of the scavenge pump than the breather intake port is.

15. A mobile object comprising
an engine including: a crankshaft that changes a reciprocating motion of a piston to a rotating motion; a crank case that supports the crankshaft; a cylinder that protrudes from the crank case to one side in a piston reciprocating direction; an oil pan that is attached to a lower side of the crank case and forms a liquid collection space for collecting oil that has lubricated a lubrication target portion in the crank case; and a scavenge pump that suctions oil from inside the liquid collection space and discharges the oil to an oil tank, wherein
a breather intake port is formed at a position facing the liquid collection space from above.

16. The mobile object according to claim 15, wherein the mobile object is an off-road wheeled vehicle.
